(19) United States
(12) Patent Application Publication
(10) Pub. No.: US 2008/0090059 A1
(43) Pub. Date: Apr. 17, 2008

(54) Scuff and Scratch Resistant Multilayer Structures

(75) Inventor: Loic Pierre Rolland, Divonne Les Bains (FR)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 11/870,304

(22) Filed: Oct. 10, 2007

Related U.S. Application Data
(60) Provisional application No. 60/852,069, filed on Oct. 16, 2006.

(51) Int. Cl. B32B 7/02; B32B 15/04; B32B 7/12; B32B 37/00

(52) U.S. Cl. 428/215; 156/60; 264/171.1; 428/332; 428/354; 428/457

(57) ABSTRACT

The invention relates to scuff and scratch resistant multilayer structures for use in building and advertising applications comprising a metal layer and a polymeric layer made of a polymeric material, said polymeric material including at least 30 wt-% of an ionomer, the weight percentage being based on the total weight of the polymeric layer.

If compared with composite panels of the state of the art, the multilayer structure of the present invention shows an improved scuff and scratch resistance, a comparable or higher resistance against abrasion and it can be manufactured at lower costs. Furthermore, the multilayer structure of the present invention shows high adhesiveness between the polymeric layer and the metal foil, high optical transparency and can be produced by a single step manufacturing process.

This application claims the benefit of U.S. Provisional Application 60/852,069, filed Oct. 16, 2006, the entire disclosure of which is incorporated herein by reference.

### FIELD OF INVENTION

The present invention relates to scuff and scratch resistant multilayer structures suitable for use in building and advertising applications. More specifically, the present invention relates to multilayer structures, for example in form of panels, having a protective surface exhibiting improved scratch and scuff resistance.

### DESCRIPTION OF THE RELATED ART

Composite panels are used in various applications, like for example as claddings of buildings and as visual displays in advertising activities. The surface of such composite panels must be scuff and scratch as well as abrasion resistant, have excellent optical properties and often have a decorative function. If used in outdoor applications, the composite panels have furthermore to be resistant to the different weathering conditions, like for example extreme temperatures, humidity, exposure to UV and other kind of radiations.

In order to achieve a certain resistance against scuff and scratch, the composite panels of the state of the art include a metal foil (in general aluminum) coated with a protective material made for example of polyvinyldifluorine (PVDF) or other coatings based on acrylates, epoxies or polyesters. Such composite panels exhibit scratch resistance which would benefit from being improved particularly if used in outdoor applications. Furthermore, these types of protective materials are usually not printable and can be usually colored only with monotone dyes so that the design possibilities on the external surface of such composite panels are limited. Additionally, the process for the manufacture of composite panels comprising the above protective materials involves at least a two-step process that is first continuous painting the rolling metal foil with the protective material and then laminating it to the other layers which will form the final composite panel. The elevated costs of the protective materials used and the complexity of the manufacturing processes render the production of these composite panels unfavorable.

There is thus a need for multilayer structures that exhibit higher scuff and scratch resistance, high abrasion resistance and which can be manufactured at reasonable costs.

### SUMMARY OF THE INVENTION

It has been surprisingly found that the above mentioned problems can be overcome by a scuff and scratch resistant multilayer structure for use in building and advertising applications comprising a metal layer and a polymeric layer made of a polymeric material, said polymeric material including at least 30 wt-% of an ionomer, the weight percentage being based on the total weight of the polymeric layer.

If compared with the composite panels of the state of the art, the multilayer structure of the present invention shows an improved scratch and scuff resistance, a comparable or higher resistance against abrasion and it can be manufactured at lower costs. Furthermore, the multilayer structure of the present invention shows high adhesiveness between the polymeric layer and the metal foil, high optical transparency and can be produced by a single step manufacturing process.

### DETAILED DESCRIPTION OF THE INVENTION

The metal layer of the multilayer structure according to the present invention can be any metal suitable for multilayer structures used in building and advertising applications and can be chosen, for example, among aluminum, stainless steel, copper, steel and alloys thereof. Aluminum is usually used due to its light weight, corrosion resistance and durability. The thickness range of the metal layer is preferably between 100 and 500 μm.

Preferably, the polymeric layer of the present invention includes the ionomer in an amount of at least 30 wt-% and still more preferably in an amount of at least 40 wt-%, the weight percentage being based on the total weight of the polymeric layer. Ionomers are thermoplastic resins that contain metal ions in addition to the organic backbone of the polymer. Ionomers are ionic copolymers of an olefin such as ethylene with partially neutralized (from 10 to 99.9%) α,β-unsaturated C₃-C₈ carboxylic acid, such as acrylic acid (AA), methacrylic acid (MAA) or maleic acid monoethylester (MAME). Neutralizing agents are alkali metals like lithium, sodium or potassium or transition metals like manganese or zinc. This peculiar structure gives to the ionomers solid-state properties which are characteristic of cross-linked polymers, as well as melt-fabricability properties which are characteristic of uncrosslinked thermoplastic polymers. Ionomers and their methods of manufacture are described for example in U.S. Pat. No. 3,264,272. Suitable ionomers for use in the present invention are commercially available under the trademark Surlyn® from E. I. du Pont de Nemours and Company, Wilmington, Del. The ionomer used in the polymeric layer of the multilayer structure according to the present invention preferably contains from about 5 to about 30 wt-% of acrylic acid, methacrylic acid and/or maleic acid monoethylester, the weight percentage being based on the total weight of the ionomer.

The thickness range of the polymeric layer of the present invention is preferably between 10 and 600 μm.

Due to the partial neutralization of the ionomer acidic functions, sufficient adhesion of the polymeric layer to the metal layer is usually achieved. However, should the adhesion be insufficient, one or more adhesive layers can be added between the metal layer and the polymeric layer. Suitable adhesive materials for the adhesive layers are for example acid copolymer resins or other adhesive resins which are commercially available from E. I. du Pont de Nemours and Company, Wilmington, Del. under the trademarks Nucrel® and Bynel®.

According to another embodiment of the present invention, the polymeric material for the polymeric layer can further comprise one or more of polyamide, polyester and polypropylene for increasing thermal stability of the polymeric layer itself when used, for example, in outdoor applications. Preferably, the polymeric material includes polyamide and more preferably, the polymeric material consists of 40 wt-% of the ionomer and 60 wt-% of the polyamide. Suitable examples of polyamide used for the polymeric layer of the multilayer structure according to the present invention are nylon 6, nylon 66, nylon 6/66, nylon 11 or nylon 12 and are described in U.S. Pat. No. 5,859,137. Preferably, the polyamide is nylon-6, for example Ultramid® B3 which is commercially available from BASF.

The multilayer structure of the present invention is manufactured by a single process which may include laminating or extrusion coating the polymeric material onto the metal layer. If one or more adhesive layers are needed between the polymeric layer and the metal layer as described above, the multilayer structure is manufactured by a single process including co-extrusion coating the adhesive layer and the polymeric material onto the metal layer.

Alternatively, the multilayer structure of the present invention including one or more adhesive layers can be manufactured by a two-step process including first the co-extrusion of the polymeric material with the adhesive material and then the application of the thus obtained two-layer film to the metal layer using for example a hydraulic press.

According to another embodiment of the present invention, the scuff and scratch resistant multilayer structure can further comprise a printable and/or colorable layer positioned between the metal layer and the polymer layer. The printable and/or colorable layer can be a polymeric film, paper, board, a woven fabric, a non-woven fabric and combinations thereof. Preferably, the thickness range of the printable and/or colorable layer is between 10 and 200 μm. The multilayer structure comprising a printable and/or colorable layer can be manufactured by means of conventional methods, like for example extrusion coating the polymer material onto the printable and/or colorable layer prior to laminate the so obtained two-layer sheet onto the metal layer. If necessary, an adhesive layer may be added between the printable and/or colorable layer and the polymeric layer and/or between the printable and/or colorable layer and the metal layer.

The present invention also relates to scuff and scratch resistant composite panels for use in building and advertising applications comprising a core layer and, adjacent thereto, a first multilayer structure as described above. Such first multilayer structure faces the core layer on the side of its metal layer. For panels used in building applications, the core layer can be made, for example, of flame retardant or other functional materials which may be required by law and can be a single or a multilayer structure. Such composite panels can be manufactured by means of conventional processes like for example (a) extrusion coating the polymeric material onto the metal layer (or, if one more adhesive layers are needed, co-extrusion coating the polymeric material and the adhesive material onto the metal layer) prior to laminating the so obtained two-layer composite with the core layer, (b) extrusion coating the core layer onto the metal layer prior to extruding the polymeric material.

According to another embodiment, the scuff and scratch resistant composite panel further comprises an additional metal layer positioned adjacent to the core layer, on the opposite side of the first multilayer structure. If necessary, a layer of a conventional adhesive is applied between the core layer and the additional metal layer. The additional metal layer confers to the panel structure itself strength, stiffness and high rigidity without substantially increasing its overall weight. Such panels can be manufactured for example (a) by laminating the core layer with the two metal layers prior to extrusion coating the polymeric material onto the metal layer or (b) by extrusion coating the polymeric material on to the metal layer prior laminating the core layer with the metal layer.

In cases where the composite panel has to be scuff and scratch resistant on both sides, it can comprise a second multilayer structure as described above which structure is positioned adjacent to the core layer and on the opposite side of the first multilayer structure. The second multilayer structure faces the core layer on the side of its metal layer so that a “double-faced” scuff and scratch resistant panel structure is obtained. Such structures can be manufactured for example by means of conventional process steps mentioned above.

The invention will be further described in the Examples below.

### EXAMPLES

The following materials were used for preparing the scuff and scratch resistant multilayer structures according to the present invention:

### Surlyn® A: a copolymer comprising ethylene and 15 wt-% MAA (methacrylic acid), wherein 58% of the available carboxylic acid moieties are neutralized with zinc cations;

### Nylon-6: Ultramid B3 (from BASF);

### Surlyn® B: a copolymer comprising ethylene, 11 wt-% MAA and 6 wt-% MAME (maleic acid monoethylester), wherein 60% of the available carboxylic acid moieties are neutralized with zinc cations;

Polyamide/Surlyn® (PA/Surlyn®) blend: A composition consisting of 59.25 wt-% Ultramid B3, 40 wt-% Surlyn® B and 0.75 wt-% zinc stearate.

### Nucrel®: a copolymer of ethylene and 9 wt % MAA.

### Example 1

### E1

Two-layer polymer sheets were first prepared by co-extruding the ionomer Surlyn® A and the copolymer Nucrel®. These films were then pressed at 150° C. onto 250 μm thick aluminum foil samples in a hydraulic press. The final structure of the sample consisted in a 150×50×0.75 mm compressed multilayer structure having a 300 μm layer of Surlyn® A, a 200 μm layer of Nucrel® and a 250 μm layer of aluminum.

Scuff and scratch resistance of the multilayer structure was then measured using an Eirichsen tester according to ISO1518 where a weight between 0.1 and 2 kg was applied onto a needle which was drawn over the polymer surface. This apparatus measured the weight in Newton at which a scratch mark was visible on the surface.

Results are shown in Table 1.

Abrasion resistance of the multilayer structure was measured according to ISO 5470-1980 where two abrasive heads were rotating on the sample surface and formed a circle having a diameter of 114 mm. The two heads applied a vertical and constant pressure of 2.45 N. The abrasive heads were made of tungsten carbide and during the test they rotated 200 times at a speed between 6.10 and 7.33 rad/s. The results show the weight difference of the samples before and after the test (loss of material). In no instance the abrasive heads reached the metal layer so that the test results in Table 2 for the six samples are directly comparable irrespective of the thickness of their polymer layer.

Results are shown in Table 2.

### Example 2

### E2

Example 1 was repeated using PA/Surlyn® blend as polymeric material for the polymeric layer. The final structure of the sample consisted in a 150×50×0.65 mm compressed multilayer structure having a 300 μm layer of PA/Surlyn® a 100 μm layer of Nucrel® and a 250 μm layer of aluminum.

Results are shown in Tables 1 and 2.

### Example 3

### E3

Example 1 was repeated with the same components. The final structure of the sample consisted in a 150×50×0.45 mm compressed multilayer structure having a 150 μm layer of Surlyn® A, a 50 μm layer of Nucrel® and a 250 μm layer of aluminum.

Results are shown in Tables 1 and 2.

For comparative purposes, the scuff and scratch resistance and abrasion resistance of the three following conventional composite panels were measured:
an aluminum foil coated with polyvinyldifulorine (PVDF), commercially available from Hermann Gutmann Werke AG (C1),
an aluminum foil coated with polyesters, commercially available from Etem (C2),
an aluminum foil coated with acrylates, commercially available from Euramax International, Inc. (C3).

TABLE 1
Scuff and scratch resistance of the examples of the present
invention and of conventional samples measured according to ISO1518.

Applied force

| | 1 | 5 | 10 | 20 |
|---|---|---|---|---|
| Sample | [N] | [N] | [N] | [N] |
| C1 | — | X | X | X |
| C2 | — | X | X | X |
| C3 | — | — | X | X |
| E1 | — | — | — | X |
| E2 | — | — | — | X |
| E3 | — | — | — | X |

TABLE 2
Abrasion resistance of the examples of the present invention and
of conventional samples measured according to ISO 5470-1980.

| | Weight | Weight | |
|---|---|---|---|
| | before | after | Loss of |
| | abrasion | abrasion | weight |
| Sample | [g] | [g] | [g] |
| C1 | 42.5818 | 42.5335 | 0.0483 |
| C2 | 28.4973 | 28.4206 | 0.0767 |
| C3 | 10.8543 | 10.8249 | 0.0294 |
| E1 | 8.4640 | 8.4490 | 0.0150 |
| E2 | 32.8507 | 32.8091 | 0.0416 |
| E3 | 33.0163 | 33.0111 | 0.0052 |

As shown in Table 1, the samples according to the present invention (E1-E3) show a visible scratch mark only after applying on their surface a force of 20 N. For comparison, an applied force of 5 N(C1 and C2) or 10 N(C3) is enough to produce a visible scratch mark on the surface of the conventional samples. Consequently, the samples of the present invention exhibit a higher scuff and scratch resistance than the conventional ones. Moreover, the reduction of the thickness of the polymeric layer including Surlyn® and Nucrel® for the samples of the present invention (C1 and C3) does not lead to a decrease of the scuff scratch and resistance. Furthermore, Table 2 shows that the samples of the present invention (E1-E3) exhibit a comparable (if not higher) resistance against abrasion as the conventional samples (C1-C3).

1. A scuff and scratch resistant multilayer structure for use in building and advertising applications comprising a metal layer and a polymeric layer made of a polymeric material, said polymeric material including at least 30 wt-% of an ionomer, the weight percentage being based on the total weight of the polymeric layer.

2. The multilayer structure according to claim 1, wherein the polymeric material includes at least 40 wt-% of the ionomer.

3. The multilayer structure according to claim 1, wherein the ionomer is a copolymer of ethylene and an unsaturated C₃-C₈ carboxylic acid.

4. The multilayer structure according to claim 3, wherein the ionomer comprises from 5 to 30 wt-% of acrylic, methacrylic acid and/or maleic acid monoethylester, the weight percentage being based on the total weight of the ionomer.

5. The multilayer structure according to claim 1, wherein the polymeric material further includes one or more of polyamide, polyester and polypropylene.

6. The multilayer structure according to claim 5, wherein the polymeric material consists of 40 wt-% of the ionomer and 60 wt-% of the polyamide.

7. The multilayer structure according to claim 1 wherein the thickness of the polymeric layer is between 10 and 600 μm.

8. The multilayer structure according to claim 1 comprising one or more adhesive layers positioned between the metal layer and the polymeric layer.

9. The multilayer structure according to claim 1, wherein the thickness of the metal layer is between 100 and 500 μm.

10. The multilayer structure according to claim 1, further comprising a printable and/or colorable layer positioned between said metal layer and said polymeric layer.

11. The multilayer structure according to claim 10, wherein the printable and/or colorable layer is a polymeric film, paper, board, a woven fabric, a non-woven fabric and combinations thereof.

12. The multilayer structure according to claim 10, wherein the thickness of the printable and/or colorable layer is between 10 and 200 m.

13. A scuff and scratch resistant composite panel for use in building and advertising applications comprising a core layer and, adjacent thereto, a first multilayer structure consisting of the multilayer structure of claim 1, the multilayer structure facing the core layer on the side of its metal layer.

14. The composite panel according to claim 13, further comprising an additional metal layer positioned adjacent to the core layer, on the opposite side of the first multilayer structure.

15. The composite panel according to claim 13, comprising a second multilayer structure of the multilayer structure of claim 1 positioned adjacent to the core layer and on the opposite side of the first multilayer structure, the second multilayer structure facing the core layer on the side of its metal layer.

16. A scuff and scratch resistant multilayer structure for use in building and advertising applications comprising:
a) a metal layer having a thickness between 100 and 500 μm; and
b) a polymeric layer made of a polymeric material and having a thickness between 10 and 600 μm, said polymeric material including at least 40 wt-%, based on the total weight of the polymeric layer, of a copolymer of ethylene and an unsaturated C₃-C₈ carboxylic acid comprising from 5 to 30 wt-%, based on the total weight of the copolymer, of acrylic, methacrylic acid and/or maleic acid monoethylester.

17. The multilayer structure according to claim 16, wherein the polymeric material consists of 40 wt-% of a copolymer of ethylene and an unsaturated C₃-C₈ carboxylic acid and 60 wt-% of a polyamide, the weight percentage being based on the total weight of the polymeric layer.

18. The multilayer structure according to claim 16 further comprising one or more adhesive layers positioned between the metal layer and the polymeric layer.

19. The multilayer structure according to claim 18, wherein the polymeric material consists of 40 wt-% of a copolymer of ethylene and an unsaturated C₃-C₈ carboxylic acid and 60 wt-% of a polyamide, the weight percentage being based on the total weight of the polymeric layer.

20. A method for avoiding scuffs and scratches on building and advertising panels based on a metal layer comprising the step of extrusion coating or laminating the metal layer with a polymeric layer made of a polymeric material including at least 40 wt-% of an ionomer.

21. The method according to claim 20, wherein the metal layer has a thickness between 100 and 500 μm and the polymeric layer is made of a polymeric material and has a thickness between 10 and 600 μm, said polymeric material including at least 40 wt-%, based on the total weight of the polymeric layer, of a copolymer of ethylene and an unsaturated C₃-C₈ carboxylic acid comprising from 5 to 30 wt-%, based on the total weight of the copolymer, of acrylic, methacrylic acid and/or maleic acid monoethylester.

22. The method according to claim 21, wherein the polymeric material consists of 40 wt-% of a copolymer of ethylene and an unsaturated C₃-C₈ carboxylic acid and 60 wt-% of a polyamide, the weight percentage being based on the total weight of the polymeric layer.
